(19) United States
(12) Patent Application Publication
(10) Pub. No.: US 2007/0229992 A1
(43) Pub. Date: Oct. 4, 2007

(54) Reflection sheets

(76) Inventors: Chi Wen Liao, Jhongli City (TW); Chi Liang Zseng, Tainan City (TW); Ching Chuan Ma, Taiping City (TW)

Correspondence Address: BROMBERG & SUNSTEIN LLP, 125 SUMMER STREET, BOSTON, MA, 02110-1618, US

(21) Appl. No.: 11/717,608

(22) Filed: Mar. 13, 2007

(30) Foreign Application Priority Data
Mar. 13, 2006 (TW) 095108394

(51) Int. Cl. G02B 5/08

(52) U.S. Cl. 359/838

(57) ABSTRACT

A reflection sheet includes a transparent substrate, a directional reflection layer formed on a first surface of the transparent substrate, and a shield reflection layer formed on the directional reflection layer. As light enters into the transparent substrate from a second surface of the transparent substrate, a first portion of the light is mirror reflected via the directional reflection layer to leave the transparent substrate, and a second portion of the light passing through the directional reflection layer leaves the transparent substrate due to shielding and reflecting of the shield reflection layer. Embodiments may additionally include a diffusion layer formed on the second surface of the transparent substrate, such that the first portion of light entering through the diffusion layer is reflected via the directional reflection layer and diffused via the diffusion layer to leave the reflection sheet, and the second portion of light passing through the directional reflection layer leaves the reflection sheet due to shielding and reflecting of the shield reflection layer. Embodiments may additionally or alternatively include an anti-oxidation layer formed in between the directional reflection layer and shield reflection layer.

### CROSS-REFERENCE TO RELATED APPLICATION

This application claims priority from Taiwan Patent Application No. 095108394 filed Mar. 13, 2006, which is hereby incorporated herein by reference in its entirety.

### FIELD OF THE INVENTION

The present invention relates to a reflection sheets, and especially to reflection sheets for backlight modules, particularly for enhancing the brightness of reflected light and the stability of chroma.

### BACKGROUND OF THE INVENTION

A conventional reflection sheet generally consists of polymer polyesters such as white polymer. The reflection effect can be achieved as the light irradiates the surface of the sheet, and the reflected light is the diffused reflected light.

However, a high brightness over the front luminance area is typically required for a V-cut light-guide structure commonly used in backlight modules; the conventional reflection sheet is generally not able to meet such requirement.

Furthermore, the white polymer of the reflection sheet may become yellow after being used for a period of time. Additionally, since variation in white polymer is typical during the manufacturing process, its XY chroma cannot be easily controlled. This often results in color variation. Due to above two factors, the change in XY chroma of the reflected light brings complications in the product application.

### SUMMARY OF THE INVENTION

One major aspect of the present invention is to provide a directional diffusion reflection layer that performs the mirror reflection and produces directional effect to the light. The brightness of the front luminance area thus can be increased.

A second aspect of the present invention is to truthfully recover the XY chroma of the reflected light with high stability of the reflection layer to the light, so that the chroma will not be affected.

A third aspect of the present invention is to shield the reflected light by coating the shield reflection layer at the back of the reflection layer, so that a portion of light passing through the reflection layer will be covered and reflected by this shield reflection layer. The brightness of the reflected light thus can be enhanced.

A fourth aspect of the present invention is to provide a diffusion layer that diffuses the reflected light, so that the luminance non-uniformity of light-emitting area due to the high directional effect produced by mirror reflection can be reduced.

According to one aspect disclosed in the present invention, there is provided a reflection sheet that includes a transparent substrate, a directional reflection layer formed on a first surface of the transparent substrate, and a shield reflection layer formed on the directional reflection layer. As light enters into the transparent substrate from a second surface of the transparent substrate, a first portion of the light is mirror reflected via the directional reflection layer to leave the transparent substrate, and a second portion of the light passing through the directional reflection layer leaves the transparent substrate due to shielding and reflecting of the shield reflection layer.

According to another aspect disclosed in the present invention, there is provided a light diffusion reflection sheet, comprising a reflection sheet as described above, and also having a diffusion layer formed on the second surface of the transparent substrate. The first portion of light entering through the diffusion layer is reflected via the directional reflection layer and diffused via the diffusion layer to leave the reflection sheet, and the second portion of light passing through the directional reflection layer leaves the reflection sheet due to shielding and reflecting of the shield reflection layer.

In various alternative embodiments, the transparent substrate may include poly(ethylene terephthalate) (PET) and/or polycarbonate (PC). The thickness of the transparent substrate may be from 12 μm to 250 μm. The directional reflection layer may include silver, mercury, and/or aluminum. The thickness of the directional reflection layer may be from 500 angstrom to 2000 angstrom. The shield reflection layer may include thermoplastic polymer resin and/or UV curable polymer resin. The thickness of the shield reflection layer may be from 5 μm to 20 μm.

In additional alternative embodiments, an anti-oxidation layer may be formed in between the directional reflection layer and shield reflection layer. The anti-oxidation layer may include epoxy resin, melamine, polyurethane (PU), polymethyl methacrylate (PMMA), ethylene vinyl acetate (EVA), and/or poly vinyl alcohol (PVA). The thickness of the anti-oxidation layer may be from 1 μm to 5 μm.

In further alternative embodiments, the diffusion layer may include diffusion particles and adhesive, wherein the adhesive is used to hold the diffusion particles to the second surface of the transparent substrate. The diffusion particles may include organic diffusion particles and/or non-organic diffusion particles. Organic diffusion particles may include PMMA, PVC, silicone, PU, and/or polystyrene (PS). Non-organic diffusion particles may include SiO2 or Al2O3. The size of the diffusion particles may be from 1 μm to 5 μm. The diffusion particles may have different refraction rates. The volume of the diffusion particles may be 5% to 40% of the total volume of the diffusion layer. The adhesive may include thermoplastic polymer resin and/or UV curable polymer resin. The thickness of the diffusion layer may be from 5 μm to 80 μm, for example, from 5 μm to 20 μm.

In various embodiments of the present invention, with the mirror reflection effect generated due to the directional reflection layer, the brightness of the front luminance area can be increased. Since the shield reflection layer is able to make the light passing through the directional reflection layer be shielded and reflected, light reduction can be lowered, overall light brightness will generally be improved, the whole physical structure will be compact, and the ability to endure high temperature and humidity can be greatly enhanced.

### BRIEF DESCRIPTION OF DRAWINGS

The foregoing and advantages of the invention will be appreciated more fully from the following further description thereof with reference to the accompanying drawings wherein:

FIG. 1 is a cross-sectional view of a reflection sheet in accordance with an exemplary embodiment of the present invention.

FIG. 2 is a cross-sectional view of a light diffusion reflection sheet in accordance with an exemplary embodiment of the present invention.

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

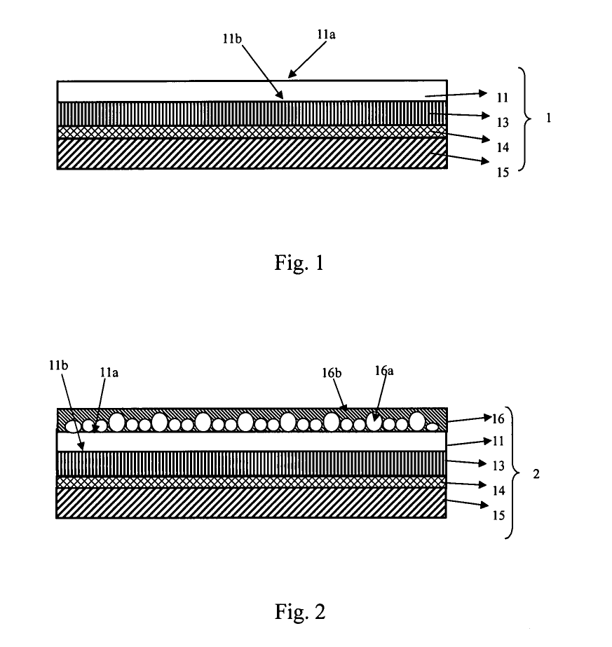

In FIG. 1, the reflection sheet 1 of one exemplary embodiment in the present invention includes a transparent substrate 11, a directional reflection layer 13, an anti-oxidation layer 14, and a shield reflection layer 15. The transparent substrate 11 has an upper surface 11a and a lower surface 11b, and, in this exemplary embodiment, the directional reflection layer 13 is disposed on the lower surface 11b. As the light enters to substrate 11 from the upper surface 11a, a large portion of the light is mirror reflected via the directional reflection layer 13 to leave transparent substrate 11, while a small portion of the light passing through the directional reflection layer 13 leaves the transparent substrate 11 due to shielding and reflecting of the shield reflection layer 15.

The materials for the transparent substrate 11 are preferably poly ethylene terephthalate (PET), polycarbonate (PC), or their combinations, although other materials may be possible. In this exemplary embodiment, substrate 11 is used as the major supporting structure of reflection sheet 1 and the thickness may be in the range of 12 μm to 250 μm.

The materials for the directional reflection layer 13 are preferably silver, mercury, aluminum, or their combinations, although other materials may be possible. Layer 13 can be formed, for example, by physical sputtering/evaporation or chemical sputtering/evaporation techniques, and its thickness may be in the range of about 500 angstrom to 2000 angstrom. The mirror reflection of the light can be generated on the surface of layer 13 so as to enhance the brightness of the reflected light.

The materials for the anti-oxidation layer 14 can be epoxy resin, melamine, polyurethane (PU), polymethyl methacrylate (PMMA), ethylene vinyl acetate (EVA), poly vinyl alcohol (PVA), or their combinations, although other materials may be possible. Anti-oxidation layer 14 can be formed, for example, by coating method and its thickness may be in the range of about 1 μm to 5 μm. Layer 14 is preferably capable of preventing oxidation of directional reflection layer 13.

The materials for the shield reflection layer 15 are preferably thermoplastic polymer resin, UV curable polymer resin or their combinations, although other materials may be possible. Layer 15 can be formed, for example, by coating method and its thickness may be in the range of 5 μm to 20 μm. Layer 15 provides shielding and reflecting of a portion of the light passing through the directional reflection layer 13, so that the light can be reflected back to the original light path and used.

In FIG. 2, a light diffusion reflection sheet 2 of another embodiment in the present invention has the general structure of the embodiment disclosed in FIG. 1, but additionally includes a diffusion layer 16 disposed on upper surface 11a of the substrate. As the light enters into light diffusion reflection sheet 2 from diffusion layer 16, a large portion of the light is reflected via the directional reflection layer 13 and diffused via the diffusion layer 16 to leave the light diffusion reflection sheet 2, while a small portion of the light passing through the directional layer 13 leaves the light diffusion reflection sheet 2 due to shielding and reflecting of the shield reflection layer 15 and diffusing of light diffusion reflection sheet 2. Such structure can control the proportion of the diffused reflected lights and mirror-reflected lights, and the proportion can be changed depending on practical needs.

In this exemplary embodiment, diffusion layer 16 includes diffusion particles 16a and adhesive 16b, although other types of diffusion layers may be used. Diffusion particles 16a may have different sizes and/or refraction rates and are able to achieve a certain level of diffusion as light passes through. Adhesive 16b is used to hold the diffusion particles to upper surface 11a of the substrate. The thickness of diffusion layer 16 may be in the range of 5 μm to 80 μm, preferably from 5 μm to 20 μm.

Diffusion particles 16a may include organic diffusion particles, non-organic diffusion particles, or their combinations. The materials for organic diffusion particles are preferably PMMA, PVC, silicon, PU, polystyrene (PS), or their combinations, although other materials may be possible. The materials for non-organic diffusion particles are preferably SiO2, Al2O3, or their combinations, although other materials may be possible. The size of diffusion particles 16a may be in the range of 1 μm to 50 μm, and the volume of diffusion particles 16a may be in the range of 0% to 90% of the total volume of diffusion layer 16, more preferably from 5% to 40%. The materials for adhesive 16b are preferably thermoplastic polymer resin, UV curable polymer resin, or their combinations, although other materials may be possible.

Table 1 as follow shows the product property chart of a silver reflection sheet of a particular exemplary embodiment. This exemplary silver reflection sheet has a directional reflection layer (silver, thickness about 1200 angstrom), an anti-oxidation layer (epoxy resin, thickness about 3 μm), a shield reflection layer (white PMMA, thickness about 6 μm), and a substrate (PET, thickness about 38 μm).

TABLE 1

| | | | Measured | |
|---|---|---|---|---|
| Test Item | | Unit | Value | Measuring Method |
| Total Thickness | | μm | 47 | |
| Substrate Thickness | | μm | 38 | |
| Reflectivity 550(nm) | | % | 94 | |
| Flame Proof | | ˜ | OK | UL94 VTM-2 |
| Heat | MD (V) | % | 1.1 | ASTM D1204 |
| Shrinkage | | | | 150° C. |
| | TD (H) | % | 0.1 | ASTM D1204 |
| | | | | 150° C. |
| Tensile | MD (V) | Kg-force/mm² | 23.2 | ASTM D882 |
| Strength | TD (H) | Kg-force/mm² | 25.5 | ASTM D882 |
| Elongation | MD (V) | % | 191 | ASTM D882 |
| at Break | | | | (JIS 2151) |
| | TD (H) | % | 174 | ASTM D882 |
| | | | | (JIS 2151) |

| | | | |
|---|---|---|---|
| Surface resistance | Ω | ≧10¹² | JIS K 6911 |

In Table 1, “V” stands for “Vertical, “H” stands for “Horizontal,” “MD” stands for “machine direction,” and “TD” stands for “transverse direction.” As shown in Table 1, the measured total thickness of the exemplary silver reflection sheet is 47 μm, the thickness of substrate is 38 μm, the reflectivity under 550 nm yellow light is 94%, and the reflection sheet is found flame proof by UL 94 VTM-2. Table 1 shows the heat shrinkage is 1.1% in machine direction (MD) and 0.1% in transverse direction (TD), measured by ASTM D1204 at temperature of 150° C. for 30 minutes. Tensile strength is 23.2 Kg-force/mm² in machine direction and 25.5 Kg-force/mm² in transverse direction, measured by ASTM D882. Elongation at break is 191% in machine direction and 174% in transverse direction, measured by ASTM D882 (JIS 2151). The measuring method of surface resistance is JIS K 6911 and the measurement value is larger than or equal to 10¹²Ω.

Reliability (RA) testing was also run on the exemplary silver reflection sheet; the result is shown in Table 2 as follows:

TABLE 2

| | | | Final | | |
|---|---|---|---|---|---|
| | | | Value | | |
| | | Initial | Tested | | |
| | | Value | (550 | X | Y |
| Test Item | Condition | (550 nm) | nm) | Chroma | Chroma |
| Before RA | | 93.25 | | 0.3171 | 0.3347 |
| High | 70° C., 95% RH, | | 93.12 | 0.3169 | 0.3344 |
| Temperature | 500 HR | | | | |
| High | | | | | |
| Humidity | | | | | |
| Thermal | −40° C.(30 mins) | | 93.07 | 0.3175 | 0.3351 |
| Shock | ˜60° C.(30 mins), | | | | |
| | 150 cycles | | | | |

As shown in Table 2, before RA, under the 550 nm yellow light, the initial value of reflectivity is 93.25, X chroma is 0.3171, and Y chroma is 0.3347. Under the condition of 550 nm yellow light and the high temperature and high humidity environment of 70° C./95% RH/500HR, the final value of reflectivity tested is 93.12, X chroma is 0.31691, and Y chroma is 0.3344. Under the condition of 550 nm yellow light and in the thermal shock of −40° C. (30 minutes)˜60° C. (30 minutes)/150 cycles, the final value of reflectivity tested is 93.07, X chroma is 0.3175, and Y chroma is 0.3351. Accordingly, the test values of the embodiment for the reflectivity, X chroma, and Y chroma are not very different from the initial values, whether before RA or after RA (e.g. high temperature high humidity test and thermal shock test). Such embodiment thus is reliable.

The present invention may be embodied in other specific forms without departing from the true scope of the invention. The described embodiments are to be considered in all respects only as illustrative and not restrictive.

What is claimed is:

1. A reflection sheet, comprising:
a transparent substrate;
a directional reflection layer formed on a first surface of said transparent substrate; and
a shield reflection layer formed on said directional reflection layer,
wherein a first portion of light entering into the transparent substrate from a second surface of the transparent substrate is mirror reflected via the directional reflection layer to leave the transparent substrate, and a second portion of the light passing through the directional reflection layer leaves the transparent substrate due to shielding and reflecting of the shield reflection layer.

2. A reflection sheet according to claim 1, further comprising:
a diffusion layer formed on the second surface of the transparent substrate, wherein the first portion of light entering through the diffusion layer is reflected via the directional reflection layer and diffused via the diffusion layer to leave the reflection sheet, and the second portion of light passing through the directional reflection layer leaves the reflection sheet due to shielding and reflecting of the shield reflection layer.

3. A reflection sheet according to any of claims 1 or 2, wherein the transparent substrate includes at least one of poly(ethylene terephthalate) (PET) and polycarbonate (PC).

4. A reflection sheet according to any of claims 1 or 2, wherein the thickness of said transparent substrate is from 12 μm to 250 μm.

5. A reflection sheet according to any of claims 1 or 2, wherein the directional reflection layer includes at least one of silver, mercury, and aluminum.

6. A reflection sheet according to any of claims 1 or 2, wherein the thickness of said directional reflection layer is from 500 angstrom to 2000 angstrom.

7. A reflection sheet according to any of claims 1 or 2, wherein the shield reflection layer includes at least one of thermoplastic polymer resin and UV curable polymer resin.

8. A reflection sheet according to any of claims 1 or 2, wherein the thickness of said shield reflection layer is from 5 μm to 20 μm.

9. A reflection sheet according to any of claims 1 or 2, further comprising an anti-oxidation layer formed in between the directional reflection layer and shield reflection layer.

10. A reflection sheet according to claim 9, wherein the anti-oxidation layer includes at least one of epoxy resin, melamine, polyurethane (PU), polymethyl methacrylate (PMMA), ethylene vinyl acetate (EVA), and poly vinyl alcohol (PVA).

11. A reflection sheet according to claim 9, wherein the thickness of said anti-oxidation layer is from 1 μm to 5 μm.

12. A reflection sheet according to claim 2, wherein the diffusion layer includes diffusion particles and adhesive, said adhesive used to hold the diffusion particles to the second surface of the transparent substrate.

13. A reflection sheet according to claim 12, wherein the diffusion particles include at least one of organic diffusion particles and non-organic diffusion particles.

14. A reflection sheet according to claim 13, wherein the organic diffusion particles include at least one of polymethyl methacrylate (PMMA), PVC, silicone, polyurethane (PU), and polystyrene (PS).

15. A reflection sheet according to claim 13, wherein the non-organic diffusion particles include at least one of SiO2 and Al2O3.

16. A reflection sheet according to claim 12, wherein the size of said diffusion particles is from 1 μm to 5 μm.

17. A reflection sheet according to claim 12, wherein the diffusion particles have different refraction rates.

18. A reflection sheet according to claim 12, wherein the volume of the diffusion particles is 5% to 40% of the total volume of said diffusion layer.

19. A reflection sheet according to claim 12, wherein the adhesive includes at least one of thermoplastic polymer resin and UV curable polymer resin.

20. A reflection sheet according to claim 2, wherein the thickness of the diffusion layer is from 5 μm to 80 μm.

21. A reflection sheet according to claim 2, wherein the thickness of said diffusion layer is from 5 μm to 20 μm.
